(19) United States
(12) Patent Application Publication
(10) Pub. No.: US 2007/0241499 A1
(43) Pub. Date: Oct. 18, 2007

(54) Behavior Modeling Board Game and Method Therefor

(76) Inventors: Andrija Novakovich, Oak Creek, WI (US); Zorka Novakovich, Oak Creek, WI (US)

Correspondence Address: Zorka Novakovich, 8810 S. 27th Street, Oak Creek, WI, 53154, US

(21) Appl. No.: 11/279,538

(22) Filed: Apr. 12, 2006

(51) Int. Cl. A63F 3/00; G09B 19/00

(52) U.S. Cl. 273/236; 273/243; 434/238

(57) ABSTRACT

A board game comprises a playing surface having a path, the path including a plurality of positions. A first player account is provided to a first player of the game. The first player account contains a balance. The board game further includes a plurality of behavior modeling cards, each card having both a value associated therewith and an explanation associated therewith. The board game further includes a first token associated with the first player. The board game includes a token progressor, wherein the token progressor regulates the advancement of the first token to cause the first token to move along the path. When the token lands on a position, one of the behavior modeling cards is selected, the explanation associated with the card is presented, and the balance of the first player account is adjusted by the value associated with the selected card.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to board games and methods for playing board games, and more particularly, to a board game having child behavior modeling and teaching properties.

### BACKGROUND OF THE INVENTION

Board games have been a staple form of child, adult and family entertainment for many years. Generally, the popularity of such games is dependent on the perceived entertainment value or competitive nature of the play of the board game relative to other available board games. Although retail cost remains a factor, players are likely to be attracted to the most entertaining, exciting and competitive board games. Board game manufacturers continuously seek new and innovative themes, game play mechanics, and features for inclusion in their board game products to increase the appeal to the player. Moreover, board games aimed at younger child players often seek to include features appealing to parents and teachers who purchase the games for play.

One such feature which has been utilized to increase the appeal of a board game to adult purchasers for play by children is educational features, themes, and subject matter. Some manufacturers have produced board games having themes and features relating to life as an adult, including aspects such as completing education, buying a home, and having a family. Other board games have educated children on the various career options available later in life, and the duties of various professions. Yet other board games have focused on the basic subjects of elementary education such as history, mathematics, reading, and science.

However, one problem that exists is that traditional board games fail to educate children by modeling behavior through positive reinforcement of acceptable behavior and dissuasion of undesirable behavior. Furthermore, board games have failed to correlate modeling children's behavior with financial gains and losses within contexts with which a child is already familiar. The present invention is directed to solving these and other problems.

### SUMMARY OF THE INVENTION

According to one aspect of the present invention, a board game comprises a playing surface having a path, the path including a plurality of positions. A first player account is provided to a first player of the game. The first player account contains a balance. The board game further includes a plurality of behavior modeling cards, each card having both a value associated therewith and an explanation associated therewith. The board game further includes a first token associated with the first player. The board game includes a token progressor, wherein the token progressor regulates the advancement of the first token to cause the first token to move along the path. When the token lands on a position, one of the behavior modeling cards is selected, the explanation associated with the card is presented, and the balance of the first player account is adjusted by the value associated with the selected card.

According to another aspect of the invention, a method of conducting a board game comprises providing a playing surface having a path, the path including a plurality of positions. Each position has a value associated therewith. The method further includes funding and providing to each player of the game a player account having a balance. The method further includes providing a plurality of behavior modeling cards, each card having an explanation associated therewith. The method includes associating a token with each player of the game and advancing at least one of the tokens along the path. The method includes, in response to the at least one token landing on a position, selecting one of the behavior modeling cards, presenting the explanation associated with the card, and adjusting the balance of the account of the player associated with the at least one token by the value associated with the position.

According to yet another aspect of the invention, a computer readable storage medium is encoded with instructions for directing a gaming device to perform the above method.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a board game embodying the present invention;

FIG. 2 is a front view of one of a plurality of positive reinforcement game cards utilized in conjunction with play of the board game of FIG. 1; and

FIG. 3 is a front view of one of a plurality of dissuasion game cards utilized in conjunction with play of the board game of FIG. 1.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

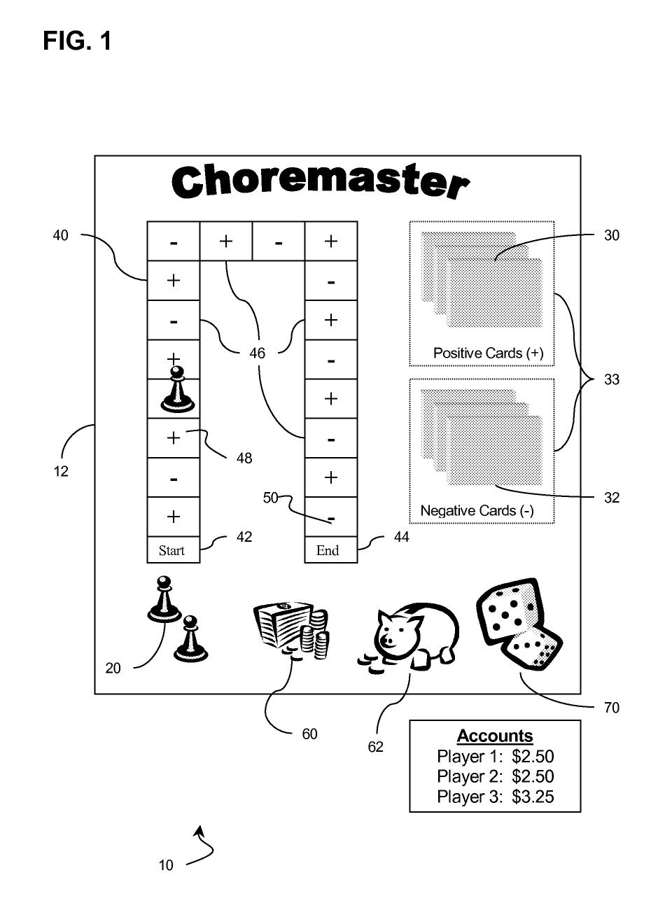

Referring to FIG. 1, a board game 10 according to the present invention is depicted, and is entitled “Choremaster™”. The board game 10 includes a playing surface 12, a path 40, a plurality of player pieces or tokens 20, two sets of behavior modeling cards 30,32. The playing surface 12 is preferably a two dimensional surface upon which play occurs, but may alternatively be a three dimensional surface. The board game 10 also includes a variety of money or currency 60 stored in a bank 62.

The playing surface 12 includes at least one path 40 upon which the player pieces 20 travel. In one embodiment, the path 40 is open ended and includes a starting position 42, an ending position 44, and a plurality of intermediate positions 46 located between the starting and ending positions 42, 44. The intermediate positions 46 comprise one or more varieties of gameplay modifiers. In one embodiment depicted in FIG. 1, the intermediate positions 46 include behavior modeling indicators, including positive behavior reinforcement indicators 48 and negative behavior dissuasion indicators 50. Each of the behavior modeling indicators 48,50 are associated with one or more behavior modeling cards 48,50.

The player tokens 20 are placed upon the playing surface 12 during play, where they traverse the path 40. The player tokens 20 may be two dimensional or three dimensional objects which vary in shape, color, texture, size or geometry. The players playing the game 10 may select from the tokens 20. The tokens 20 serve to mark a player's position on the path 40, so as to indicate the player's progression along the path 40 from the starting position 42 to the ending position.

The board game 10 also includes at least one token progressor 70, which preferably comprises a die or dice. The token progressor 70 is actuated or activated by a player at the beginning of his turn and indicates how far along the path 40 that player's token 20 is to be moved or progressed. The token progressor 70 may alternatively comprise a spinner, a card chosen from a set of cards, movement markers on the positions 46 of the path 40 (e.g. go forward three spaces), or virtually any other random number generating device.

The game further includes currency 60 which is initially stored in a bank 62. Each player in the game is given a predetermined amount of currency 60 which constitutes an account balance for such player. Each player's account balance is credited and debited during gameplay with associated behavior values 64, as described further herein. In one embodiment, as shown in FIG. 1, each behavior modeling indicator 48,50 is associated with either (i) at least one of the behavior modeling cards, or (ii) at least one behavior value 64, or both. The value 64 associated with each behavior modeling indicator 48,50 may be written on the indicator 48,50 itself, the position 46 bearing the indicator 48,50, or may alternatively be written elsewhere such as on one of the cards 30,32. In other embodiments, the value 64 may be randomly associated with the indicator 48,50, such as by drawing one of the cards 30,32, or by some other random event or generator (e.g. rolling a dice, picking a number, drawing straws, drawing cards, etc.)

The playing surface 12 may also include one or more card areas 33 where the behavior modeling cards 30,32 are placed. The behavior modeling cards 30,32 include positive behavior reinforcement cards 30 and negative behavior dissuasion cards 32.

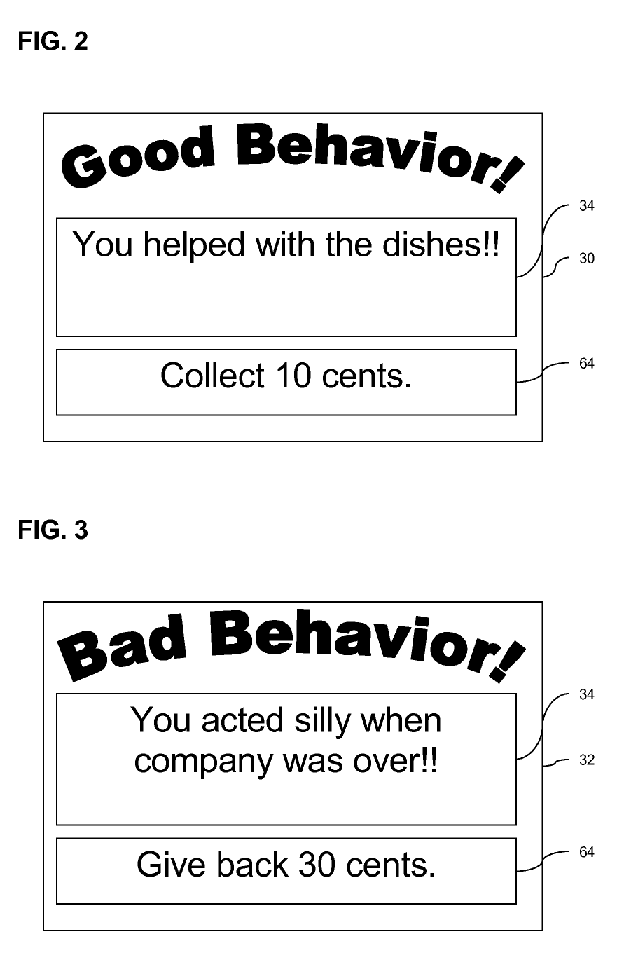

Turning to FIG. 2, a positive behavior reinforcement card 30 is depicted. The positive behavior reinforcement card 30 includes an explanation 34 constituting the positive reinforcement. As seen in FIG. 2, the explanation 34 is “You helped with washing the dishes.” The explanation 34 serves as a message to the player receiving the card 30 that this behavior is desirable. The explanation 34 on the positive behavior reinforcement card 30 is associated with a positive behavior value 64. In one embodiment, as seen in FIG. 2, the positive behavior value 64 is shown on the card 30. Thus, the positive behavior reinforcement card 30 includes the language “Collect 10 cents.” Alternatively, the value 64 may be shown on the corresponding position 46 on the path, or on some other location on the board 12. A player drawing this card would be credited ten cents ($0.10) from the bank 62 thereby increasing his account balance. In this way, the explanation 34 in conjunction with the card 32 and the negative value 64 causing the player's account to be debited serves to dissuade the undesirable

Turning to FIG. 3, a negative behavior dissuasion card 32 is depicted. The negative behavior dissuasion card 32 also includes an explanation 34 which in this case constitutes negative dissuasion. As seen in FIG. 3, the explanation 34 is “You acted silly when company was over.” The explanation 34 serves as a message to the player receiving the card 32 that this behavior is not desirable. The explanation 34 on the negative behavior dissuasion card 32 is associated with a negative behavior value 64. In one embodiment, as seen in FIG. 3, the negative behavior value 64 is shown on the card 32. Thus, the negative behavior reinforcement card 30 includes the language “Give back 30 cents.” Alternatively, the value 64 may be shown on the corresponding position 46 on the path, or on some other location on the board 12. A player drawing this card would be debited thirty cents ($0.30) from his account balance, which would be returned to the bank 62. In this way, the explanation 34 in conjunction with the card 32 and the negative value 64 causing the player's account to be debited serves to dissuade the undesirable behavior.

At the beginning of play of the game 10, the players place their tokens 20 on the starting position 42. An initial account balance is given to each player in the form of a predetermined amount of currency 60 given from the bank 62 (e.g. $2.50). The initial currency 60 distributed to each player, in one embodiment, may represent the money that player has in his or her piggy bank. Preferably, each player receives the same initial currency 60 and account balance. Players determine an order of play, either randomly (e.g. rolling the dice to see who goes first, second, third, etc.) or may agree amongst themselves in what order they will play. The positive behavior reinforcement cards 30 and negative behavior dissuasion cards 32 are randomized (i.e. shuffled) and placed in the designated card area(s) 33 on the playing surface 12. Preferably, the cards 30,32 are placed face down so as not to be visible until selected.

When it is a player's turn during the game 10, he or she actuates the token progressor 70 and moves his or her token 20 forward along the path 40 the number of spaces indicated by the token progressor 70. Depending on the variety of the position 46 on the path 40, the player follows one of a variety of instructions. If the player lands on a position 46 bearing a behavior modeling indicator 48,50, he or she chooses a card 30,32 corresponding to the type of indicator 48,50 on the position 46. If the position 46 includes a positive behavior reinforcement indicator 48, the player selects a card from the positive behavior reinforcement cards 30. If the position 46 includes a negative behavior dissuasion indicator 50, the player selects a card from the negative behavior reinforcement cards 32. The cards 30,32 therefore simulate the giving of awards or allowance for positive behavior and the concept of punishment for negative behavior.

Once a card 30,32 is selected, the player reads both the explanation 34 on the card 30,32, and the associated value 64 of the card 30,32. If the card is a positive behavior reinforcement card 30, the player receives currency 60 in the amount of the value 64 on the card, and his or her account is credited by such amount. If the card is a negative behavior dissuasion card 32, the player must give back currency 60 in the amount of the value on the card, and his or her account is debited such amount. The play of the game 10 then passes to the next player in the predetermined order.

Play of the game continues until game play reaches a terminating condition, which is established by the rules of the game 10. The terminating condition in one embodiment is that all of the player tokens 20 have advanced to the ending position 44 on the playing surface 12. At such time, the account balances of the players are compared and the player having the highest balance is declared the winner, with the other players finishing in rank in accordance with their respective account balances. In another embodiment, play continues until a player reaches a predetermined account balance (e.g. $5.00). Numerous other termination conditions may be utilized such as accumulation of a predetermined number of cards, traversing the path 40 a predetermined number of times, etc.

In one alternate embodiment, the path 40 may be closed end, such as a continuous loop. In such an arrangement, the path 40 may include a starting position 42, but no ending position 44. The path 40 may also be configured to have one or more sub-paths or routes thereon. Thus, the path 40 may include features such as forks in the road, tunnels, transporters, slides, ladders, and other devices so as to move player tokens 20 around the path 40 in various ways.

In another alternate embodiment, the amount of the values 64 associated with the cards 30,32 is proportional or commensurate with the perceived value of the behavior on the card 30,32. For example, an extremely highly valued behavior, or tough chore, such as “Mowing the lawn” may be rewarded with a large positive value (e.g. $1.00), while a lesser chore such as “Making the bed” may be rewarded with a relatively smaller positive value (e.g. $0.25). Similarly, an extremely undesirable negative behavior may be punished and debited more severely than a perceived lesser negative behavior.

In another alternate embodiment, the values 64 may be credited and debited from a player's account and distributed to other players of the game 10. For example, a player receiving a negative dissuasion card 32 thereby causing him to give back some currency 60 may have such currency placed in a holding area to be won by another player receiving a positive reinforcement card 30. Alternatively, an amount debited from one player may immediately be given to another player either randomly or by some predetermined set of rules (e.g. the currency 60 may be given to the player sitting to the right of the player receiving the negative dissuasion card 32.)

Although in FIG. 1, the behavior modeling indicators 48,50 are depicted as “plus” and “minus” signs, many other indicia may be used. For example, the positions 46 may be labeled as “Good boy” and “Naughty boy” to indicated desirable and undesirable behavior positions 46. Moreover, the indicators 48,50 may be color coded, text, graphics, or any other display so as to label the position 46 on which the player has landed as one requiring the selection of either a positive behavior reinforcement card 30 or a negative behavior dissuasion card 32.

The game 10 may also be programmed for play on a computer having a display, a processor, and computer readable storage such as memory, hard disks, floppy disks, CD-rom, etc. The game 10 may include graphical representations of the game elements described herein (playing surface 12, path 40, tokens 20, cards 30,32, etc.) which may be displayed via the display of the computer. The display and execution of the game 10 may be programmed and transferred to the computer memory where it is executed by the processor so as to be visible on the computer display. In this way, the game 10 may be executed solely or partially on a computer rather than on a standalone playing surface 12.

Furthermore, although the behavior described herein with reference to the game 10 focuses on child behavior and chores, any multitude of behavior modeling can be accomplished with the present invention. For example, teaching driving skills to adolescents or life skills to inmates are other varieties of behavior modeling that may be accomplished. The desired positive and negative behaviors are stressed when coupled to the positive and negative values 64 of the game 10, wherein the values 64 are preferably monetary. However, in alternate embodiments, the values 64 need not be monetary but should preferably be distinguishable between a “positive” value and a “negative” value.

One benefit of the game 10 and method therefore described herein is the teaching of concepts such as responsibility, financial management, reward and punishment, particularly to child aged players. The maintaining of an account balance along with credits thereto and debits there from teach mathematical skills to players. Moreover, the association of positive rewards and negative punishments with desirable and undesirable behavior teach behavior and etiquette to such players. The game 10 is designed to provide an entertaining educational experience to player, particularly children.

Each of these embodiments and obvious variations thereof is contemplated as falling within the spirit and scope of the claimed invention, which is set forth in the following claims.

What is claimed is:

1. A board game comprising:
a playing surface having a path, the path including a plurality of positions;
a first player account provided to a first player of the game, the first player account containing a balance;
a plurality of behavior modeling cards, each card having both a value associated therewith and an explanation associated therewith;
a first token associated with the first player;
a token progressor, wherein the token progressor regulates the advancement of the first token to cause the first token to move along the path, wherein when the token lands on a position:
(i) one of the behavior modeling cards is selected;
(ii) the explanation associated with the card is presented; and
(iii) the balance of the first player account is adjusted by the value associated with the selected card.

2. The board game of claim 1, wherein the path includes a starting position and an ending position.

3. The board game of claim 1, wherein the plurality of positions include at least one positive behavior reinforcement position and at least one negative behavior dissuasion position.

4. The board game of claim 3, wherein the positive behavior reinforcement position is associated with one or more positive behavior reinforcement cards selected from the plurality of behavior modeling cards.

5. The board game of claim 3, wherein each of the positive behavior reinforcement cards is associated with a positive value.

6. The board game of claim 3, wherein the negative behavior dissuasion position is associated with one or more negative behavior reinforcement cards selected from the plurality of behavior modeling cards.

7. The board game of claim 6, wherein each of the negative behavior reinforcement cards is associated with a negative value.

8. The board game of claim 1, further comprising a second player account provided to a second player of the game, and further comprising a second token associated with the second player, wherein the first and second players play the game by actuating the token progressor in a predetermined order.

9. The board game of claim 1, wherein the value associated with each behavior modeling card is printed on at least one of the card, the path, or the playing surface.

10. The board game of claim 1, wherein the explanation associated with each behavior modeling card is printed on at least one of the card, the path, or the playing surface.

11. A method of conducting a board game comprising:
providing a playing surface having a path, the path including a plurality of positions, each position having a value associated therewith;
funding and providing to each player of the game a player account having a balance;
providing a plurality of behavior modeling cards, each card having an explanation associated therewith;
associating a token with each player of the game;
advancing at least one of the tokens along the path, and in response to the at least one token landing on a position:
(i) selecting one of the behavior modeling cards;
(ii) presenting the explanation associated with the card; and
(iii) adjusting the balance of the account of the player associated with the at least one token by the value associated with the position.

12. The method of claim 11, wherein the path includes a starting position and an ending position.

13. The method of claim 11, wherein the plurality of positions include at least one positive behavior reinforcement position associated with a positive value and at least one negative behavior dissuasion position associated with a negative value.

14. The method of claim 13, wherein in response to the at least one token landing on a positive behavior reinforcement position, the selected card is a positive behavior reinforcement card.

15. The method of claim 13, wherein in response to the at least one token landing on a negative behavior dissuasion position, the selected card is a negative behavior dissuasion card.

16. The method of claim 13 wherein the amount of the positive value is a function of a perceived desirability of a positive behavior associated with the at least one positive behavior reinforcement position.

17. The method of claim 11, further comprising the step of declaring as the winner the player with the highest player account balance after all of the tokens have reached a predetermined position on the path.

18. The method of claim 11, wherein the step of presenting the explanation comprises printing the explanation on the associated card.

19. The method of claim 11, wherein the step of selecting one of the behavior modeling cards comprises player selection.

20. A computer readable storage medium encoded with instructions for directing a computer to perform the method of claim 11.
